(19) United States
(12) Patent Application Publication
(10) Pub. No.: US 2017/0148092 A1
(43) Pub. Date: May 25, 2017

(54) Mortgage-Based Loan Program that Executes through a Unique Loan Processing System

(71) Applicants: Kevin Wooseung Chang, Rancho Santa Margarita, CA (US); Saman Kim, Irvine, CA (US)

(72) Inventors: Kevin Wooseung Chang, Rancho Santa Margarita, CA (US); Saman Kim, Irvine, CA (US)

(21) Appl. No.: 15/357,239

(22) Filed: Nov. 21, 2016

Related U.S. Application Data
(60) Provisional application No. 62/257,998, filed on Nov. 20, 2015.

(51) Int. Cl. G06Q 40/02; G06Q 50/16

(52) U.S. Cl. CPC G06Q 40/025; G06Q 50/16

(57) ABSTRACT

A computer-implemented mortgage loan processing system comprises a host in a merchant financing processor and work flow engine in an escrow. The host processes card sales transaction log data for the entities and extracts information from viewpoint of predetermined categories with a data mining algorithm. The workflow engine processes information for clearing & settling payments under predetermined escrow rules, which are provided by the host that modifies the escrow rules based on the categories processed from the card transaction. The merchant financing processor provides a predetermined portion of the loan for the merchant, which acts as a mortgage to reinforce the merchant's credit. The remaining portion of the loan is provided by co-lenders. A mortgage loan method uses the system such that the merchant finance processor provides fund to merchants with future card receivables from merchants as collateral.

### CROSS-REFERENCE TO RELATED APPLICATION

This application claims priority on Provisional Application No. 62/257,393, filed on 20 Nov. 2015, the disclosure of which is incorporated by reference herein.

### FIELD OF THE INVENTION

The present invention is related to an automated loan processing system. More specifically, the present invention is related to a unique loan processing system that provides fast and detailed control for mortgage-based loan program.

### BACKGROUND OF THE INVENTION

Most small merchants operate under comparatively low quality of life. Severe asymmetry between lender and borrower exists in the financial market. 92% of the small merchants in US could not finance conventionally. There are loan programs that use a merchant's account receivables as the collateral. From a lender's viewpoint, high default rate is the obstacle to extend credit for small merchants. From a small merchant's viewpoint, tough qualification and high interest rate are the obstacles to obtain a loan. Large portion of such merchants' income comes from credit card sales. Involving large number of transactions and complex clearing and settling processes are difficulties for developing a viable loan program and processing algorithms, which utilize credit card receivables for collateral.

### BRIEF SUMMARY OF THE INVENTION

An objective of the present invention is to provide a loan processing system that enables fast and predictable repayment. Another objective of the present invention is to provide a loan processing and repayment algorithm that utilizes precise, detailed and latest data elements for credit-card transactions.

In order to achieve the objectives, the present invention provides a computer-implemented mortgage loan processing method, wherein the method is performed by a machine with a memory having machine-executable instructions stored therein, the machine executing the instructions, the machine and instructions in combination implementing user interface logic, the user interface logic being accessible by entities, comprising steps of a) establishing contract relations between a merchant and a merchant financing processor; b) executing a loan, wherein the merchant financing processor provides a predetermined portion of the loan for the merchant, wherein the predetermined portion acts as a mortgage to reinforce the merchant's credit wherein the remaining portion of the loan is provided by one or more co-lenders; c) undergoing a standard card transaction process between predetermined relationships; d) storing card sales transaction logs in a database and encrypting the card sales transaction logs; e) transferring the encrypted card sales transaction logs to the merchant financing processor; f) sending request to payment to an escrow from the merchant financing processor to an acquirer or from the merchant to the acquirer; g) making payment by the acquirer to the escrow; h) transferring information for clearing & settling from the merchant financing processor to the escrow; and i) processing the information for clearing & settling payments among merchants, co-lenders and the merchant financing processor by the escrow.

The predetermined relationships comprise acquirer and card issuer, card holder and card issuer, acquirer and merchant, merchant and card holder.

The merchant financing processor comprises a host that receives the card sales transaction logs transferred from the merchant's terminals and acquirer's terminals, wherein a program in the terminals encrypts the card sales transaction logs.

The host of the merchant financing processor processes the card sales transaction log data and extracts information from viewpoint of predetermined categories with a data mining algorithm.

The predetermined categories comprise time of the transaction, purchase amount of the transaction, goods and or services purchased by the transaction, geographical location of the transaction, the merchant characteristic and the card holder characteristic.

The escrow comprises a workflow engine that processes the information for clearing & settling payments under predetermined escrow rules, wherein the escrow rules are provided by the host of the merchant financing processor, wherein the host modifies the escrow rules based on the categories processed from the card transaction. The escrow makes payments to the merchant financing processor, the co-lenders and/or the merchants.

The user interface logic provides the categories of the transaction processed by the host of the merchant financing processor to predetermined entities,

The present invention also provides a computer-implemented mortgage loan processing system comprising a machine; a memory having machine-executable instructions stored therein, the machine executing the instructions, the machine and instructions in combination implementing user interface logic, the user interface logic being accessible by entities; and a database storing a plurality of transaction logs,

The machine comprises a host in a merchant financing processor and work flow engine in an escrow, wherein the host the merchant financing processor processes card sales transaction log data for the entities and extracts information from viewpoint of predetermined categories with a data mining algorithm.

The entities comprise a card issuer, a card holder, an acquirer, a processor, a merchant, an escrow, a co-lender fund, and a merchant financing processor.

The workflow engine processes information for clearing & settling payments under predetermined escrow rules, wherein the escrow rules are provided by the host of the merchant financing processor, wherein the host modifies the escrow rules based on the categories processed from the card transaction.

The merchant financing processor provides a predetermined portion of the loan for the merchant, wherein the predetermined portion acts as a mortgage to reinforce the merchant's credit wherein the remaining portion of the loan is provided by one or more co-lenders.

The advantageous effects of the present invention are: (1) loan repayment is performed in secure, speedy and predictable manner; (2) escrow module provides an objective trusted platform; (3) the system lowers the risk of the bank, and increases benefits for merchants; (4) the feature of sub-security reinforces credit, drastically expands opportunities for the co-lenders and reduces operation burden of the merchant financing provider; (5) the system turns future potential into augmented real-life loan; (6) the system facilitates easy access by business partners and networks including lenders, acquiring banks, escrow companies, processors, legal consultants, auditors/accountants, independent sales organizations/contractors; (7) the system offers better overall quality of life by reinforcing credit line and providing merchants customized cash advance and management services, with a secure loan using future credit card receivables as collateral; (8) the system helps in increasing the amount of an eligible loan by bumping up credit lines/ratings of merchants; (9) the system builds the trust-first relationship with customers by providing escrow services; (10) the system provides online and offline membership service that maximizes effective use of the features of the system; (11) the system's website and mobile app provide fast screening of applicants' qualifications; and (12) the system is especially useful for merchants who want/need cash advance in lump sum to better the quality of life and/or for business expansion, who have fair credit ratings, who are ineligible for regular loans, who run a business of a high card sales volume and who have been running a business over some time,

### BRIEF DESCRIPTION OF THE DRAWINGS

The invention will be more fully understood by reference to the detailed description in conjunction with the following figures, wherein:

FIG. 1 is a block diagram showing related entities and data flow between them for a loan processing system according to the present invention;

FIG. 2 is a block diagram showing contracting process between merchants and a merchant financing provider;

FIG. 3 is a block diagram showing transaction processes between related entities;

FIG. 4 is a block diagram showing functions of an escrow module;

FIG. 5 is a schematic diagram showing basic entities related to the system and their interactions;

FIG. 6 is a flow diagram showing a method of the present invention; and

FIG. 7 is a block diagram showing the system of the present Invention.

### DETAILED DESCRIPTION OF THE INVENTION

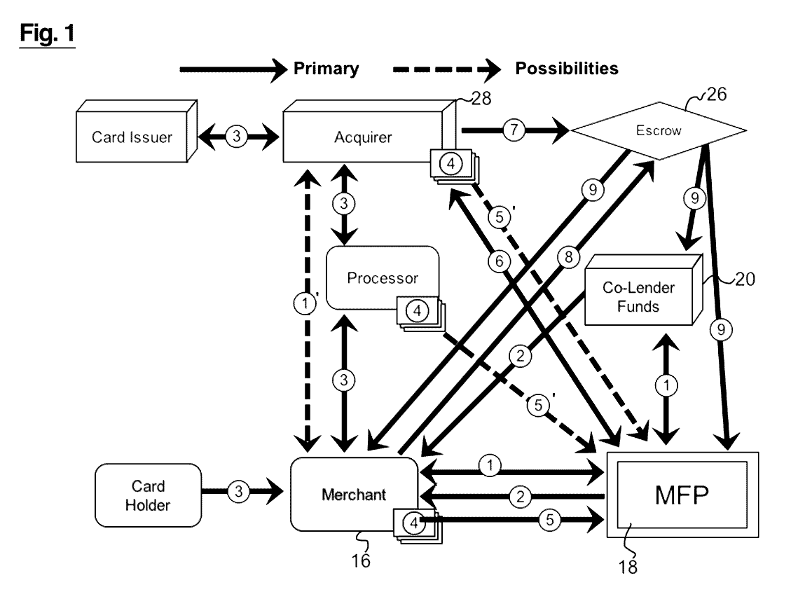

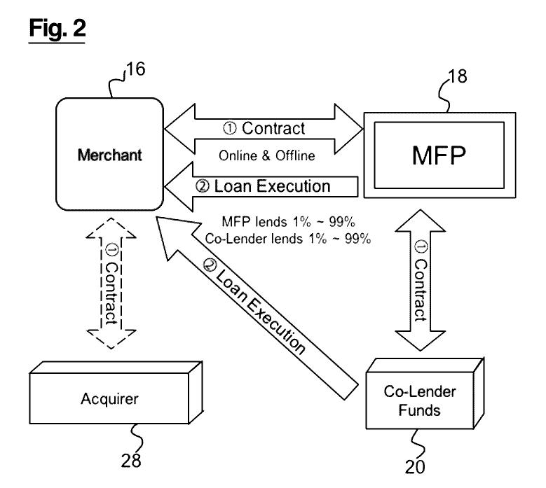

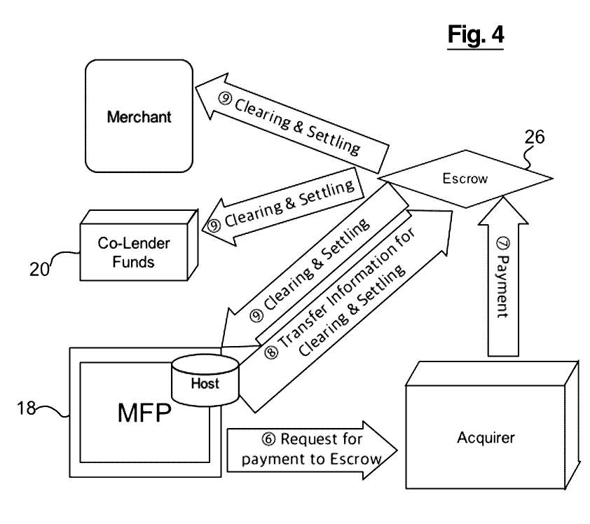

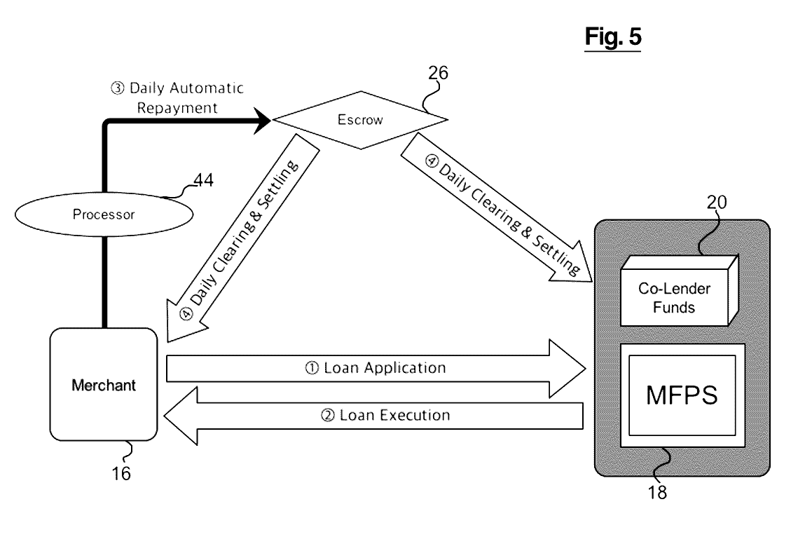

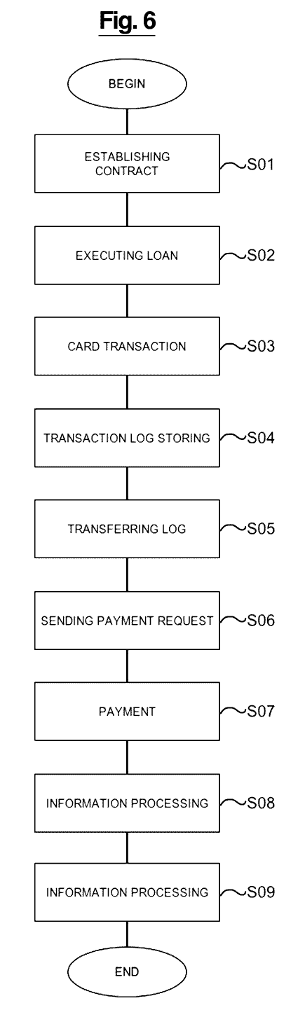

Referring FIGS. 1-7, a computer-implemented mortgage loan processing method, wherein the method is performed by a machine 10 with a memory 12 having machine-executable instructions stored therein, the machine 10 executing the instructions, the machine and instructions in combination implementing user interface logic 14, the user interface logic 14 being accessible by entities, comprises steps of S01, establishing contract relations between a merchant 16 and a merchant financing processor 18; S02, executing a loan, wherein the merchant financing processor 18 provides a predetermined portion of the loan for the merchant 16, wherein the predetermined portion acts as a mortgage to reinforce the merchant's credit wherein the remaining portion of the loan is provided by one or more co-lenders 20; S03, undergoing a standard card transaction process between predetermined relationships; S04, storing card sales transaction logs 22 in a database 24 and encrypting the card sales transaction logs 22; S05, transferring the encrypted card sales transaction logs 22 to the merchant financing processor 18; S06, sending request to payment to an escrow 26 from the merchant financing processor 18 to an acquirer 28 or from the merchant 16 to the acquirer 28; S07, making payment by the acquirer 28 to the escrow 26; S08, transferring information for clearing & settling from the merchant financing processor 18 to the escrow 26; and S09, processing the information for clearing & settling payments among merchants 16, co-lenders 20 and the merchant financing processor 18 by the escrow 26.

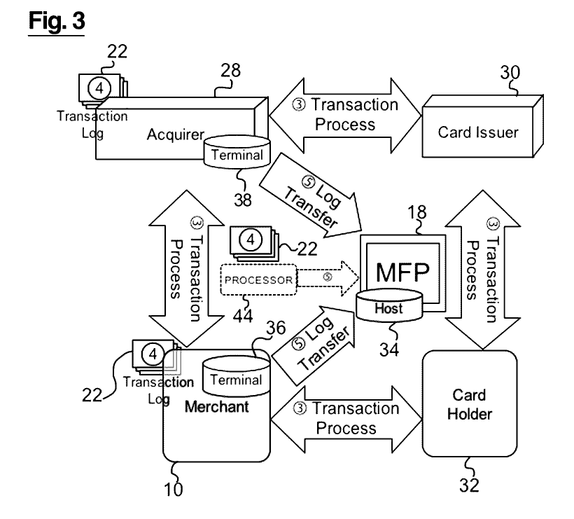

Referring to FIG. 3, the predetermined relationships comprise acquirer 28 and card issuer 30, card holder 32 and card issuer 30, acquirer 28 and merchant 16, merchant 16 and card holder 32, Referring to FIG. 1, primary relationships between entities are illustrated as solid lines, and possibilities are illustrated as dotted lines.

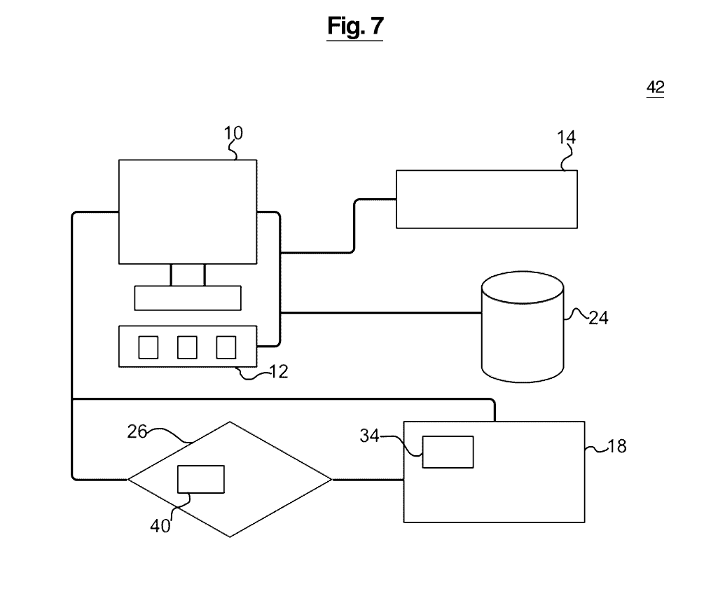

Referring to FIGS. 3 and 7, the merchant financing processor 18 comprises a host 34 that receives the card sales transaction logs 22 transferred from the merchant's terminals 36 and acquirer's terminals 38. A program in the terminals 36, 38 encrypts the card sales transaction logs 22.

The host 34 of the merchant financing processor 18 processes the card sales transaction log data 22 and extracts information from viewpoint of predetermined categories with a data mining algorithm.

The predetermined categories comprise time of the transaction, purchase amount of the transaction, goods and or services purchased by the transaction, geographical location of the transaction, the merchant characteristic and the card holder characteristic.

The escrow 26 comprises a workflow engine 40 that processes the information for clearing & settling payments under predetermined escrow rules, wherein the escrow rules are provided by the host 34 of the merchant financing processor 18, wherein the host 34 modifies the escrow rules based on the categories processed from the card transaction log 22. The escrow 26 makes payments to the merchant financing processor 18, the co-lenders 20 and/or the merchants 16.

The user interface logic 14 provides the categories of the transaction processed by the host 34 of the merchant financing processor 18 to predetermined entities. The user interface logic may be connected to an online customer service platform.

Referring to FIG. 7, a computer-implemented mortgage loan processing system 42 comprises the machine 10, the memory 12, the user interface logic 14 and the database 24. The machine 10 comprises the host 34 in the merchant financing processor 18 and the work flow engine 40 in the escrow 26.

The entities comprise a card issuer 30, a card holder 32, an acquirer 28, a processor 44, a merchant 16, an escrow 26, a co-lender fund 20, and a merchant financing processor 18.

The merchant financing processor 18 provides a predetermined portion of the loan for the merchant, wherein the predetermined portion acts as a mortgage to reinforce the merchant's credit wherein the remaining portion of the loan is provided by one or more co-lenders 20. In one embodiment, the predetermined portion is 10% of the total loan amount. This percentage may be adjusted depending on various factors including the analysis result by the host 34.

Key activities of the system 42 includes sales & credit Evaluation, credit line confirmation, provides loan with 90% (co-lenders) + 10% (merchant financing processor, MFP), collecting merchants' card receivables from the acquiring bank, settling and clearing accounts via escrow service, and post-loan management.

When a loan is executed, the loan consists of two parts, one (1%-99%) from MFP and the other (1%-99%) from co-lenders, with both adding up to 100% of a needed loan. As MFP requests for payment to Escrow, it also transfers from its Host an encrypted information to Escrow to help Escrow clear and settle accounts. With the encrypted information received from MFP Host, Escrow then clears and settles accounts between merchant, co-lender, and MFP.

The above description is illustrative and is not restrictive, and, as it will become apparent to those skilled in the art upon review of the disclosure, the present invention may be embodied in other specific forms without departing from the essential characteristics thereof. The scope of the invention should, therefore, be determined not with reference to the above description, but instead should be determined with reference to the following and pending claims along with their full scope of equivalents.

1. A computer-implemented mortgage loan processing method, wherein the method is performed by a machine with a memory having machine-executable instructions stored therein, the machine executing the instructions, the machine and instructions in combination implementing user interface logic, the user interface logic being accessible by entities, comprising steps of:
a) establishing contract relations between a merchant and a merchant financing processor;
b) executing a loan, wherein the merchant financing processor provides a predetermined portion of the loan for the merchant, wherein the predetermined portion acts as a mortgage to reinforce the merchant's credit wherein the remaining portion of the loan is provided by one or more co-lenders;
c) undergoing a standard card transaction process between predetermined relationships;
d) storing card sales transaction logs in a database and encrypting the card sales transaction logs;
e) transferring the encrypted card sales transaction logs to the merchant financing processor;
f) sending request to payment to an escrow from the merchant financing processor to an acquirer or from the merchant to the acquirer;
g) making payment by the acquirer to the escrow;
h) transferring information for clearing & settling from, the merchant financing processor to the escrow; and
i) processing the information for clearing & settling payments among merchants, co-lenders and the merchant financing processor by the escrow.

2. The method of claim 1, wherein the predetermined relationships comprise acquirer and card issuer, card holder and card issuer, acquirer and merchant, merchant and card holder.

3. The method of claim 2, wherein the merchant financing processor comprises a host that receives the card sales transaction logs transferred from the merchant's terminals and acquirer's terminals, wherein a program in the terminals encrypts the card sales transaction logs.

4. The method of claim 3, wherein the host of the merchant financing processor processes the card sales transaction log data and extracts information from viewpoint of predetermined categories with a data mining algorithm.

5. The method of claim 4, wherein the predetermined categories comprise time of the transaction, purchase amount of the transaction, goods and or services purchased by the transaction, geographical location of the transaction, the merchant characteristic and the card holder characteristic.

6. The method of claim 5, wherein the escrow comprises a workflow engine that processes the information for clearing & settling payments under predetermined escrow rules, wherein the escrow rules are provided by the host of the merchant financing processor, wherein the host modifies the escrow rules based on the categories processed from the card transaction.

7. The method of claim 6, wherein the user interface logic provides the categories of the transaction processed by the host of the merchant financing processor to predetermined entities.

8. A computer-implemented mortgage loan processing system comprising:
a machine;
a memory having machine-executable instructions stored therein, the machine executing the instructions, the machine and instructions in combination implementing user interface logic, the user interface logic being accessible by entities; and
a database storing a plurality of transaction logs;
wherein the machine comprises a host in a merchant financing processor and work flow engine in an escrow, wherein the host of the merchant financing processor processes card sales transaction log data for the entities and extracts information from viewpoint of predetermined categories with a data mining algorithm.

9. The system of claim 8, wherein the entities comprise a card issuer, a card holder, an acquirer, a processor, a merchant, an escrow, a co-lender fund, and a merchant financing processor.

10. The system of claim 9, wherein the workflow engine processes information for clearing & settling payments under predetermined escrow rules, wherein the escrow rules are provided by the host of the merchant financing processor, wherein the host modifies the escrow rules based on the categories processed from the card transaction.

11. The system of claim 10, wherein the merchant financing processor provides a predetermined portion of the loan for the merchant, wherein the predetermined portion acts as a mortgage to reinforce the merchant's credit wherein the remaining portion of the loan is provided by one or more co-lenders.

12. The method of claim 6, wherein the escrow makes payments to the merchant financing processor, the co-lenders and/or the merchants.
